(19) United States
(12) Patent Application Publication
(10) Pub. No.: US 2003/0207246 A1
(43) Pub. Date: Nov. 6, 2003

(54) Assessment and monitoring system and method for scoring holistic questions

(76) Inventors: Scott Moulthrop, Converse, TX (US); Tom Reznick, San Antonio, TX (US); Shane Richard, San Antonio, TX (US); Lois L. Barth, San Antonio, TX (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/136,615

(22) Filed: May 1, 2002

(51) Int. Cl. G09B 7/00

(52) U.S. Cl. 434/353

(57) ABSTRACT

The method for assessing and monitoring a scorer engaged in scoring an answer to an open-ended question includes the step of retrieving from an electronic database a reevaluation record. The reevaluation record includes a student response to an open-ended question and a score awarded thereto by a scorer. The reevaluation record is displayed to a manager, who is then permitted to reevaluate the awarded score. If the awarded score is different from the reevaluated score, the awarded score is replaced with the reevaluated score in the reevaluation record. Then the reevaluation record is stored in the database. The system includes an electronic database having stored thereon a reevaluation record. A processor is in signal communication with the database, and a display and an input device in signal communication with the processor. Software for carrying out the method steps is resident on the processor.

### BACKGROUND OF THE INVENTION

1. Field of the Invention

The present invention relates to systems and methods for assessing and monitoring scoring effectiveness and, more particularly, to such systems and methods for assessing and monitoring holistic scoring.

2. Description of Related Art

The automation of test scoring is a complex problem that has generated a great deal of interest, owing to a significant economic pressure to optimize efficiency and accuracy and to minimize human involvement. Open-ended or essay-type questions must typically be scored by a human reader, and thus either the physical test form or a visible image thereof must be available for at least the time required for scoring. In addition, scorers (also referred to as readers or resolvers) must be trained in order to become accomplished in analyzing and scoring the answers to open-ended questions effectively, accurately, and quickly. Further, once trained, scorers should preferably be monitored to ensure continuing effectiveness.

Computerized systems for scoring open-ended questions are known in the art. In addition, such systems are known that provide feedback to a scorer on validity, reliability, and speed based upon a standard question and model answer. For example, Clark and Clarket al. (U.S. Pat. Nos. 5,321,611; 5,433,615; 5,437,554; 5,458,493; 5,466,159; and 5,558,521) disclose systems and methods for collaborative scoring, wherein scores of two or more resolvers are compared, and a record is kept of each of the resolver's scores. This group of patents also teach the collection of feedback on a resolver, which includes the monitoring of scoring validity, reliability, and speed. One of the criteria is a calculation of a deviation of the resolver's score and a model score by using “quality items.” Also discussed is an on-line scoring guide for use by the resolver during scoring.

A system and method for teaching and assessing scorers has also been taught in U.S. Pat. No. 6,267,601, which is co-owned with the present application, and the disclosure of which is incorporated hereinto by reference.

However, there are no systems and methods known in the art that are specifically directed to the assessment and monitoring scorers of open-ended questions.

### SUMMARY OF THE INVENTION

It is therefore an object of the present invention to provide a system and method for assessing and monitoring a scorer's grading of an open-ended question.

It is an additional object to provide such a system and method for adjusting a score that has been re-examined.

It is another object to provide such a system and method for electronically communicating with a scorer.

It is a further object to provide such a system and method that improve scoring validity and consistency.

These and other objects are achieved by the system and method of the present invention. One aspect of the method is for assessing and monitoring a scorer engaged in or having completed the scoring of an answer to an open-ended question. Holistic scoring is a technique whereby a unitary, typically numerical, score is given for an answer to an open-ended question; for example, in an essay-type response, spelling and grammatical errors and content are all taken into account when granting a score. In analytic scoring multiple scores are assigned to a student response based upon various features assessed independently by a reader.

The method of the present invention comprises the step of retrieving from an electronic database a reevaluation record. The reevaluation record comprises a student response to an open-ended question and a score awarded thereto by a scorer. The reevaluation record is displayed to a manager, who is then permitted to reevaluate the awarded score. The manager may be referred to in the art as a team leader, a room director, or a manager, although these terms are not intended as limitations, and there may be set up a hierarchy of a plurality of levels of managers.

If the awarded score is different from the reevaluated score, the awarded score is replaced with the reevaluated score in the reevaluation record. Then the reevaluation record is stored in the database.

The system of the present invention comprises an electronic database having stored thereon a reevaluation record comprising a student response to an open-ended question and a score awarded thereto by a scorer. The system also comprises a processor in signal communication with the database and a display and an input device in signal communication with the processor.

Software means are resident on the processor that are adapted to retrieve the reevaluation record from the database into the processor and direct a display of the reevaluation record to a manager on the display. The software means are also adapted to receive a selection based upon a reevaluation of the awarded score from the manager via the input means. The selection comprises one of a confirmation and an overriding of the awarded score with a reevaluated score. If the selection comprises an overriding of the awarded score, the software means replaces the awarded score with the reevaluated score in the reevaluation record and stores the reevaluation record in the database. If the selection comprises a confirmation, the software means deletes the reevaluation record.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIGS. 1A-1D is a logic flowchart for the method of the present invention for assessing and monitoring a scorer in a holistic scoring technique.

FIG. 2 is a schematic diagram of the system of the present invention.

### DETAILED DESCRIPTION OF THE PREFERRED EMBODIMENTS

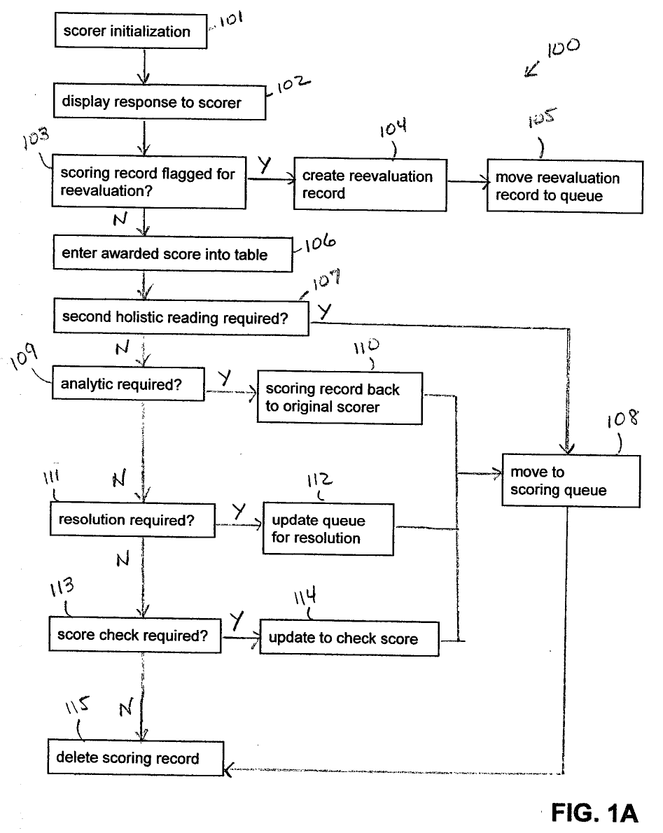

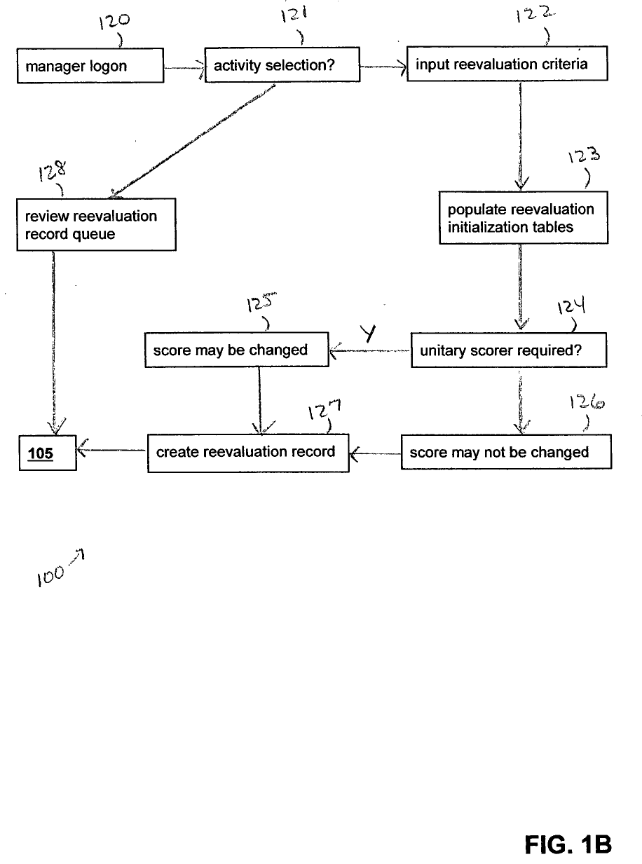

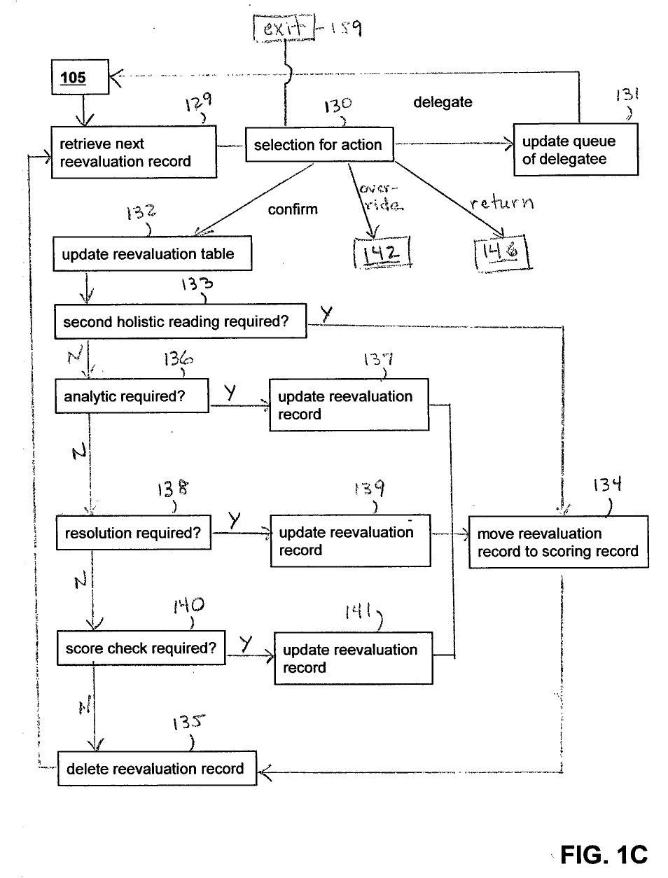

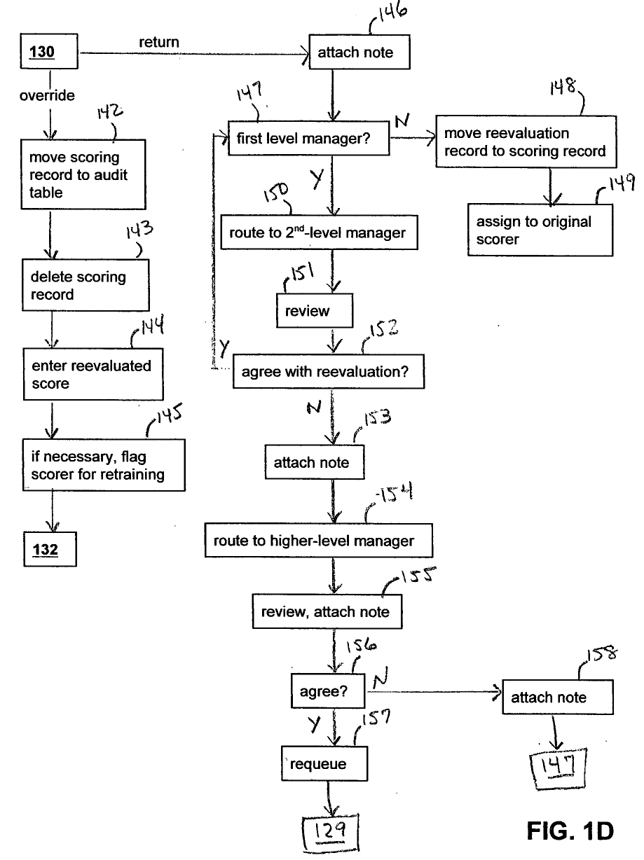

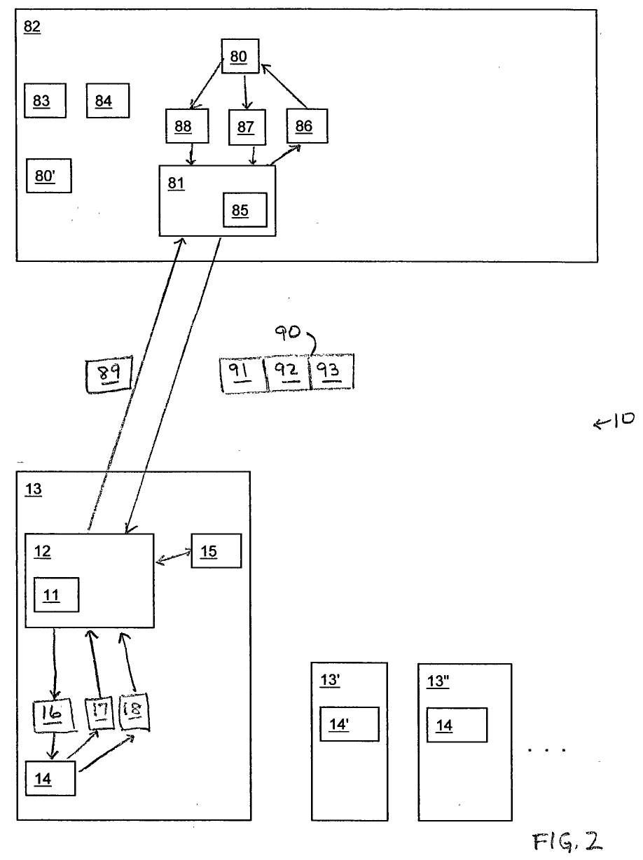

A description of the preferred embodiments of the present invention will now be presented with reference to FIGS. 1A-2.

A preferred embodiment of the method 100 of the present invention is illustrated in FIGS. 1A-1D; the system 10 of the invention is illustrated in FIG. 2. At least one scorer 80 engaged in or having been engaged in holistic and/or analytic scoring is provided with access to a processor 81 at a scoring site 82. The means of access may also, for scorer 80′, comprise a personal computer or a workstation 83 or terminal networked to a server computer 84, or an interface to a remote site through telecommunications, internet, intranet, or other forms of data transmission, although these architectures are not intended to be limiting. The processor 81 has loaded thereon scoring software 85, which has been described in the aforementioned U.S. Pat. No. 6,267,601. The computer access/interface is preferably provided by means well known in the art, e.g., via a display screen 86, keyboard 87, and pointing device 88 such as a mouse, for use in a Windows™-type or Macintosh environment.

The preferred embodiment of the method 100 (FIGS. 1A-1D) is for assessing and monitoring a scorer 80 who has holistically and/or analytically scored an answer or response to an open-ended question (also referred to as an “assessment” or “assessment form” in the art) via a computer-driven assessment application 11 resident on a processor 12 at a central site 13 wherein is located at least one manager 14 in charge of at least one scorer 80. The central site 13 and the scoring site 82 may in fact be coincident, or they may be remote from each other. The central site 13 may also comprise a plurality of central sites 13, 13′, 13″, . . . , at each of which is located a different manager 14 or, for example, a higher-level manager 14′.

The initial scoring section of the method 100 (FIG.1 A) comprises the portion involving the scorer 80. The initialization (block 101) of the first section of the method, which includes permitting the scorer 80 to log onto the system, training the scorer 80 in scoring a particular type of answer, and retrieving a scoring record 89 (an answer to a unitary question) from an electronic database 15 comprising a queue of like scoring records for scoring, will not be detailed here, as it has been previously disclosed in U.S. Pat. No. 6,267,601.

Following the initialization, a student response to an open-ended question is displayed to a scorer 80 (block 102), and the processor 81 receives a score awarded to the answer from the scorer 80. In addition to a numerical score, the scorer 80 may also be instructed to select from among one or more comments to include in the scoring record 89. For example, a drop-down list of “commendations” or “deficiencies” may be accessed. In essay writing, for instance, such comments may be made on topic development and conventions (grammar, spelling, etc.). If two scorers 80, 80′ are assigned to each scoring record 89, then not only must their scores be the same, but their comments must also not conflict; discrepancies are referred to a manager 14.

If the scoring record 89 has been flagged for reevaluation (block 103), a reevaluation record 90 is created (block 104), which comprises the answer 91, the score 92 given by the scorer 80, and the scorer's identification 93. The reevaluation record 90 is moved to a reevaluation record queue 94 in the database 15, or in another database if desired (block 105).

If the scoring record 89 has not been flagged for reevaluation (block 103), the awarded score is entered into a table (block 106). If the scoring record 89 has been flagged for a second holistic reading (block 107), it is moved to another scoring record queue (block 108) for scoring by another scorer 80′. If no second holistic reading is required (block 107), a check is made for whether an immediate second reading by the same scorer 80 is required (block 109), which is called an “analytic,” and includes addressing specific features of the answer. If so, the scoring record 89 is assigned again to the same scorer 80 (block 110) and moved to his/her queue (block 108). If not, a check is made for whether resolution is required (block 111), in which case the queue is updated to reflect this (block 112); otherwise, a check is made as to whether the score needs to be checked (block 113), causing an update to reflect this (block 114). The score checking function permits a manager to re-score an answer without having the scorer's score displayed to the manager. If the score does not need to be checked (block 113), the scoring record 89 is deleted (block 115).

In the “analytic” scoring process, multiple scores are assigned to a student response based upon various features assessed independently, for example, by one or more scorers. Such features may include, but are not intended to be limited to, spelling, word usage, topic development, conventions, and grammar. These scores can also be reviewed by feature and by scorer if desired.

The system 10 also permits reviewing a desired percentage of a scorer's scores, such as 10% of the scores of a scorer in a particular scoring group or “team.” A multiplicity of criteria may be searched on for evaluating, such as test batch, geographical region, analytic feature, score point or range by analytic feature, invalid code, invalid code by analytic feature, one or more items in a record, date range, or comment attached.

The reevaluation section of the method 100 operates upon the queue created when the scoring record 89 has been flagged for reevaluation at block 103. In the manager initialization subsection (FIG. 1B), the manager 14 logs onto the application 11 on the processor 12 (block 120). It should be noted that in a preferred embodiment a particular authorization should be required for access into the reevaluation section of the method 100, and that access would normally not be granted to a scorer 80 not at a predetermined management level. The manager 14, after having completed a successful logon, selects (block 121) which activity he/she wishes to pursue, such as the inputting of reevaluation criteria (block 122), which comprises the population of reevaluation initialization tables (block 123). If the scoring record 89 under consideration is set to be scored by a unitary scorer 80 (block 124), the score may be changed (block 125); otherwise, the score may not be changed (block 126). Next a reevaluation record is created (block 127) from previously scored scoring records 89, which are then added to the reevaluation record queue (block 105).

If the selected activity (block 121) is to review the reevaluation record queue (block 128), the manager 14 is sent to the reevaluation record queue (block 105). A selection may be made, for example, to search using one or more search criteria, such as a scorer identity, and forming a queue of records meeting the search criteria for review. It is also possible to search for records on an entire population (“team”) of scorers 89 for monitoring that team as a whole, or a plurality of teams if desired. Further, a search can be made on one or more order numbers or testing district, for example. In addition, a search can be configured to perform an nth select, that is, to select every five or every ten scores to review. Additionally, it may be desired to review only a particular score range to detect if a scorer 80 is grading too easily or too harshly.

The manager 14 is then permitted to retrieve a reevaluation record 90 for display 16 (FIG. 1C; block 129) and reevaluation of the awarded score. The manager 14 may make a selection (block 130) via an input device such as a mouse 17 or keyboard 18 to delegate the reevaluation record 90 to another manager 14′, which causes that manager's queue to be updated (block 131) and sent to the queue (block 105). Preferably the manager 14 is also given the option to attach a comment to the delegation request. The step of delegating the reevaluation record 90 also causes the new manager 14′ to become the “manager of record,” replacing the original manager 14 in that position for this particular record 90.

If the manager's selection (block 130) is to confirm the scorer's awarded score, a reevaluation table is updated (block 132), and a check is made as to whether a second holistic reading is required (block 133). If so, the reevaluation record 90 is moved to a scoring record 89 (block 134), and that reevaluation record 90 is deleted (block 135), permitting the retrieval of the next reevaluation record 90 in the queue (block 129).

If a second holistic reading was not required (block 133), a check is made as to whether an immediate analytic was required (block 136). If so, the reevaluation record 90 is updated to reflect this (block 137), and the reevaluation record 90 is assigned to the original scorer 89 and moved to the scoring record 89 (block 134). If an immediate analytic was not required (block 136), a check is made as to whether resolution was required (block 138). If so, the reevaluation record 90 is thereby updated (block 139) and sent to a scoring record 89 (block 134) if not, a check is made as to whether the score needs to be checked (block 140). If so, the reevaluation record 90 is thereby updated (block 141) and sent to a scoring record 89 (block 134); if not, the reevaluation record is deleted (block 135), permitting the retrieval of the next reevaluation record 90 in the queue (block 129). This part of the method 100 may be repeated until the queue is empty or until manager logoff.

If the manager's selection (block 130) is to override the scorer's awarded score (FIG. 1D), the scoring record 89 is moved to an audit table (block 142) for tracking a number of occurrences of differences between the awarded score and the reevaluated score for that scorer 80, and the scoring record 89 is deleted (block 143). A reevaluated score is then entered (block 144). If the number of occurrences for a particular scorer 80 exceeds a predetermined limit, the scorer 80 is preferably flagged for retraining (block 145). Preferably the manager 14 is also given the choice of whether or not to send a message to the original scorer 80 regarding the changing of the score. Then the reevaluation record updated (block 132), and the flow continues as on FIG. 1C.

In addition, the manager 14 is able from block 130 to return the record 90 to the original scorer 80, in which case a notification is attached if desired to the reevaluation record (block 146) regarding the overridden score. If the original scorer 80 was not a first-level manager 14 (block 147), such as a room director, the reevaluation record 90 is moved to a scoring record 89 (block 148) and assigned to the original scorer 80 (block 149). If the original scorer 80 was a first-level manager 14 (block 147), the reevaluation record 90 is routed to a second-level manager 14′ (block 150), who reviews the reevaluation record 90 and note (block 151). If he/she agrees with the reevaluation (block 152), the query at block 147 is re-asked; if not, a note is attached (block 153), and the reevaluation record 90 is routed to a higher-level manager 14″ (block 154), who reviews the reevaluation record 90 and attaches another note (block 155). If agreement is reached here (block 156), the record 90 is re-queued (block 157), and record retrieval is resumed (block 129). If agreement is not reached (block 157), a note is again attached (block 158) prior to reasking the query at block 147.

Preferably the system 10 only permits the return of a record to the scorer 80 by a particular manager 14, i.e., the manager of record. This allows that manager 14 to view any subsequent comments made by upper-level managers 14′ prior to the routing of the record back to the original scorer 80.

Finally, the manager 14 is able to select from block 130 to exit the program (block 159).

In a preferred embodiment of the invention, account is also taken of the timeliness of the reevaluation process. For example, a date may be set whereby review is permitted thereafter based upon a desired criterion. Also, if reviewing scores that are older than a predetermined limit, the system 10 may be configured to prevent the overriding of scores if a multiple scoring has occurred. However, even under these conditions, comments may be sent to the original scorer or to other reviewers if desired. A score may still be overridden if it belongs in the category of a single scorer performing a single holistic reading. If other scores by another scorer are present, all scores may be considered for making a final decision.

It may be appreciated by one skilled in the art that additional embodiments may be contemplated, including similar methods and systems for training personnel in scoring open-ended questions for other fields.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiment thereof, and the advantageous new and useful results obtained thereby, the new and useful constructions, and reasonable mechanical equivalents thereof obvious to those skilled in the art, are set forth in the appended claims.

What is claimed is:

1. A computerized method for assessing and monitoring a scorer engaged in scoring an answer to an open-ended question, the method comprising the steps of:
retrieving from an electronic database a reevaluation record comprising a student response to an open-ended question and a score awarded thereto by a scorer;
displaying the reevaluation record to a manager;
permitting the manager to reevaluate the awarded score; and
if the awarded score is different from the reevaluated score, replacing the awarded score with the reevaluated score in the reevaluation record and storing the reevaluation record in the database.

2. The method recited in claim 1, wherein the retrieving step comprises the steps of:
selecting a reevaluation record search criterion;
searching the database using the search criterion; and
forming a queue of reevaluation records meeting the search criterion.

3. The method recited in claim 2, wherein the search criterion comprises a scorer identity.

4. The method recited in claim 3, further comprising the steps of repeating the displaying, permitting, replacing, and storing steps for each reevaluation record in the queue until the queue is empty.

5. The method recited in claim 4, further comprising the step of tracking a number of occurrences of differences between the awarded score and the re-evaluated score for the scorer.

6. The method recited in claim 5, further comprising the step, if the number of occurrences exceeds a predetermined limit, of flagging the scorer for retraining.

7. The method recited in claim 2, wherein the displaying step comprises displaying the reevaluation records in the queue sequentially to the manager.

8. The method recited in claim 1, further comprising the step of permitting the manager to delegate the reevaluation record to another manager for reevaluation.

9. The method recited in claim 1, further comprising the steps of, preceding the retrieving step, of:
displaying a student response to an open-ended question to a scorer;
receiving a score for the question from the scorer;
creating a reevaluation record comprising the open-ended question and the score; and
storing the reevaluation record in the database.

10. A computerized method for assessing and monitoring a scorer engaged in scoring an answer to an open-ended question, the method comprising the steps of:
retrieving from an electronic database a reevaluation record comprising a student response to an open-ended question and a score awarded thereto by a scorer;
displaying the reevaluation record to a manager;
permitting the manager to reevaluate the awarded score; and
if the awarded score is different from the reevaluated score, permitting a selection to be made from among the choices of:
replacing the awarded score with the reevaluated score in the reevaluation record and storing the reevaluation record in the database;
delegating the reevaluation record to another manager for reevaluation; and
returning the reevaluation record to the scorer for rescoring.

11. The method recited in claim 10, wherein, if the returning selection is made, permitting the manager to enter a comment into the reevaluation record.

12. The method recited in claim 10, wherein, if the returning selection is made, adding the reevaluation record to a scorer queue for rescoring.

13. A computerized system for assessing and monitoring a scorer engaged in scoring an answer to an open-ended question, the system comprising:
an electronic database having stored thereon a reevaluation record comprising a student response to an open-ended question and a score awarded thereto by a scorer;
a processor in signal communication with the database;
a display and an input device in signal communication with the processor; and
software means resident on the processor adapted to:
retrieve the reevaluation record from the database into the processor;
direct a display of the reevaluation record to a manager on the display;
receive a selection based upon a reevaluation of the awarded score from the manager via the input means, the selection comprising one of a confirmation and an overriding of the awarded score with a reevaluated score;
if the selection comprises an overriding of the awarded score, replace the awarded score with the reevaluated score in the reevaluation record and store the reevaluation record in the database; and
if the selection comprises a confirmation, deleting the reevaluation record.

14. The system recited in claim 13, wherein the selection further comprises delegation of the reevaluation record to another manager for reevaluation; and wherein the software means is further adapted to route the reevaluation to another manager for reevaluation.

15. The system recited in claim 13, wherein the selection further comprises return of the reevaluation record to the scorer for rescoring; and wherein the software means is further adapted to route the reevaluation record to the scorer for rescoring.

16. The system recited in claim 15, wherein the software means is further adapted to, if the selection comprises a return to the scorer, permit the manager to add a comment to the reevaluation record for viewing by the scorer.

17. The system recited in claim 13, wherein the software means is further adapted to receive from the input device a selection of a search criterion, to search the database using the search criterion, and to form a queue of reevaluation records meeting the search criterion.

18. The system recited in claim 17, wherein the search criterion comprises a scorer identity.

19. The system recited in claim 18, wherein the software means is further adapted to repeat the retrieve, direct, receive, replace, and store functions for each reevaluation record in the queue until the queue is empty.

20. The system recited in claim 19, wherein the software means is further adapted to track a number of occurrences of differences between the awarded score and the reevaluated score for the scorer.

21. The system recited in claim 20, wherein the software means is further adapted, if the number of occurrences exceeds a predetermined limit, to flag the scorer for retraining.

22. The system recited in claim 17, wherein the software means is further adapted to display the reevaluation records in the queue sequentially to the manager.

23. The system recited in claim 13, wherein the software means is further adapted to receive from the manager direction to delegate the reevaluation record to another manager for reevaluation and to route the reevaluation record to the delegated manager.

24. The system recited in claim 13, further comprising:
a scorer processor in signal communication with the database;
a scorer display and a scorer input device in signal communication with the scorer processor; and
scorer software means resident on the scorer processor adapted to:
display a student response to an open-ended question on the scorer display;
receive a score for the question from the scorer via the input device;
create a reevaluation record comprising the open-ended question and the score; and
store the reevaluation record in the database.
